(19) United States
(12) Patent Application Publication
(10) Pub. No.: US 2025/0149538 A1
(43) Pub. Date: May 8, 2025

(54) LITHIUM-ION BATTERY WITH LOW TEMPERATURE RAPID CHARGE CAPABILITY

(71) Applicant: The Regents of the University of Michigan, Ann Arbor, MI (US)

(72) Inventors: Tae Ho CHO, Ann Arbor, MI (US); Neil DASGUPTA, Ann Arbor, MI (US); Yuxin CHEN, San Jose, CA (US)

(21) Appl. No.: 18/935,076

(22) Filed: Nov. 1, 2024

Related U.S. Application Data
(60) Provisional application No. 63/595,519, filed on Nov. 2, 2023.

(51) Int. Cl. H01M 4/04; H01M 4/02; H01M 4/583; H01M 4/66; H01M 10/0525; H01M 10/0562; H01M 10/44

(52) U.S. Cl. CPC H01M 4/0473; H01M 4/0407; H01M 4/583; H01M 4/667; H01M 10/0525; H01M 10/0562; H01M 10/443; H01M 10/446; H01M 10/448; H01M 2004/027

(57) ABSTRACT

A lithium-ion battery includes an electrode with microscale channels formed in the electrode material and a nanoscale conformal coating over the electrode material. The channels promote Li-ion transport to the interior of the electrode during charging, and the coating acts as an artificial solid electrolyte interphase (SEI) in place of the SEI that is typically formed during initial charge cycles of a Li-ion battery. The coating can be selected to have a lower impedance than a naturally formed SEI and can be formed in a more controlled manner prior to cell assembly. Cold-charging performance of the resulting battery is enhanced more than would be expected by the individual contributions of the channels and the coating.

### TECHNICAL FIELD

This disclosure is related to lithium-ion batteries and, in particular, to lithium-ion battery electrodes that improve battery charging characteristics.

### BACKGROUND

Lithium-ion (Li-ion) batteries represent the present state-of-the-art in portable energy storage, and their demand is projected to increase significantly due to the increasing demand for electric vehicles and portable electronics. Despite improvements over time in energy density and cost, Li-ion batteries (LIBs) are still limited to relatively low charging rates. Fast-charging capability is essential to more widespread adoption and consumer acceptance of electric vehicles to replace conventional fossil fuel vehicles with the goal of reducing greenhouse gas emissions. When conventional Li-ion batteries are charged at high C-rates, the cells suffer from accelerated capacity fading, which is detrimental to the lifespan of the batteries.

A state-of-the-art Li-ion battery cell typically pairs a graphite negative electrode with a positive electrode formed from lithium mixed metal-oxides such as LiₓNi_{y}MnCoO (NMC) or LiₓNiCoAlO (NCA). One problem encountered during fast-charging of a conventional Li-ion battery is lithium metal plating on the surface of the intercalation-based graphite electrode. This phenomenon is one of the primary sources of capacity fade and can pose safety hazards. Li-plating can be triggered during fast charging as a result of the high anode overpotential. Mass transport limitations within the porous electrode structure can lead to increased cell polarization that causes lithium to plate out as metallic filaments rather than intercalate between the layers of the graphite electrode structure as intended. This can lead to a permanent loss of transportable Li-ions in a cell, which is highly correlated with capacity fade.

Another problem with graphite electrodes is its poor performance during low temperature charging. Low temperature impedes charge-transfer at the electrode-electrolyte interphase and Li-ion transport in the naturally formed solid electrolyte interphase (SEI), electrolyte, and electrodes, leading to significant capacity loss. For example, a conventional graphite electrode may retain only 12% of its initial capacity when lithiation (charging) and delithiation (discharging) are both carried out at −20° C., while capacity retention increases to 92% when lithiation is carried out at room temperature. Attempts to improve low temperature cycling have focused on asymmetric temperature modulation and electrolyte modifications. Despite some incremental improvements, charging performance at temperatures below 0° C. is still very limited.

### SUMMARY

Embodiments of a lithium-ion battery include a negative electrode formed from an electrode material, channels formed at least partially through a thickness of the electrode material, a coating disposed over the electrode material, and a liquid electrolyte infiltrating pores of the electrode. The coating suppresses formation of a solid electrolyte interphase layer from constituents of the liquid electrolyte when the battery is initially charged.

The lithium-ion battery may include any combination of one or more of the above-listed features and/or the following features:
the coating is a solid electrolyte material that reduces interfacial resistance relative to said solid electrolyte interface layer;
each channel is defined by a channel wall, and the coating is disposed along the channel wall;
the battery includes a separator confronting a face of the electrode, and the coating is present along the face of the electrode and extends along each channel wall from the first face of the electrode;
the coating is a conformal coating on the electrode material such that the electrode material is encapsulated by the coating;
the electrode material comprises graphite;
graphite is the only electrochemically active lithium host material of the electrode material;
the electrode material further comprises silicon or hard carbon;
the coating is glassy lithium borate-lithium carbonate;
the battery has an initial charge capacity and a post-cycling charge capacity that is at least 50% of the initial charge capacity after 100 charge-discharge cycles at a cycling temperature less than or equal to 5° C. and at a charge rate of at least 4 C;
the electrode has an areal charge capacity of at least 3 mAh/cm²;
the post-cycling charge capacity is at least 90% of the initial charge capacity;
the cycling temperature is less than or equal to −10° C.;
each channel has a width in range from 5 μm to 100 μm and each channel is spaced apart from another channel by a distance in a range from 10 μm to 200 μm as measured between centerlines of the channels; and
the channels are formed by laser ablation.

Embodiments of a lithium-ion battery have an initial charge capacity and a post-cycling charge capacity that is at least 90% of the initial charge capacity after 100 charge-discharge cycles at a cycling temperature less than or equal to 5° C. and at a charge rate of at least 4 C, wherein a negative electrode of the battery has an areal charge capacity of at least 3 mAh/cm².

The lithium-ion battery may include any combination of one or more of the above-listed features and/or the following features:
the battery includes a negative electrode formed from a graphite-based electrode material, an array of laser-formed channels extending at least partially through a thickness of the electrode material, each channel having a width of 100 μm or less, an artificial sold electrolyte interphase material encapsulating the electrode material and having a thickness of 100 nm or less.

Embodiments of a method include the step of charging a lithium-ion battery at a temperature less than or equal to 5° C. at a charge rate of at least 4 C, wherein the battery is configured to suppress formation of lithium plating on a negative electrode of the battery during the step of charging.

The method may include any combination of one or more of the above-listed features and/or the following features:
discharging the lithium-ion battery after the step of charging, and repeating the steps of charging and discharging at least 100 times each, wherein the battery is substantially free from lithium plating on the negative electrode after repeating the steps of charging and discharging at least 100 times each;
the battery retains at least 90% of an initial charge capacity after repeating the steps of charging and discharging at least 100 times each;
before the step of charging: constructing the battery from the negative electrode, a positive electrode, a separator, and a liquid electrolyte; and providing the negative electrode with an artificial solid electrolyte interphase coating before constructing the battery, wherein the coating suppresses formation of lithium plating on the negative electrode during the step of charging;
atomic layer deposition of the coating; and
forming channels at least partially through a thickness of an electrode material of the negative electrode via laser ablation before the step of providing.

### BRIEF DESCRIPTION OF THE DRAWINGS

FIG. 1 is a schematic cross-sectional view of a portion of an embodiment of a Li-ion battery.

FIG. 2 is an SEM photomicrograph of a cross-section of a patterned and coated Li-ion battery illustrating a channel formed through the electrode material.

FIG. 3 is an enlarged view of a portion of the coated electrode material from FIG. 2, illustrating a graphite particle that has been cut through.

FIG. 4 illustrates EDS elemental mapping of carbon for the portion of FIG. 3 outlined with a broken rectangle;

FIG. 5 illustrates EDS elemental mapping of oxygen (O) for the portion of FIG. 3 outlined with the broken rectangle;

FIGS. 6-11 illustrates the state-of-charge (SOC) of Li-ion cells over one hundred charging cycles at various temperatures and charge rates, where each figure includes data for Li-ion cells equipped with control anodes, coated anodes, patterned anodes, and coated-and-patterned anodes, and the charge rates and temperatures are as follows:

FIG. 6 illustrates a 4 C charge rate at 30° C.;

FIG. 7 illustrates a 6 C charge rate at 30° C.;

FIG. 8 illustrates a 4 C charge rate at 5° C.;

FIG. 9 illustrates a 6 C charge rate at 5° C.;

FIG. 10 illustrates a 4 C charge rate at −10° C.; and

FIG. 11 illustrates a 6 C charge rate at −10° C.

FIG. 12 illustrates the Coulombic efficiency of Li-ion cells over one hundred charging cycles at various temperatures and charge rates, where each plot (A-F) includes data for Li-ion cells equipped with control anodes, coated anodes, patterned anodes, and coated-and-patterned anodes, and the combinations of charge rates and temperatures include: (A) 4 C charge rate at 30° C., (B) 6 C charge rate at 30° C., (C) 4 C charge rate at 5° C., (D) 6 C charge rate at 5° C., (E) 4 C charge rate at −10° C., (F) 6 C charge rate at −10° C.

FIG. 13 illustrates voltage traces of the 1st and 100th 4 C and 6 C fast-charge cycles at 5° C. for Li-ion cells equipped with control anodes, coated anodes, patterned anodes, and coated-and-patterned anodes.

FIG. 14 illustrates the same sets of voltage traces as in FIG. 13, except at −10° C.

FIG. 15 includes photomicrographs of the separator-side face (top) and cross-section (bottom) of control anodes and patterned anodes after charging for 10 minutes at 5° C. at a 6 C charge rate.

FIG. 16 includes photomicrographs of the separator-side face (top) and cross-section (bottom) of coated anodes and coated-and-patterned anodes after charging for 10 minutes at 5° C. at a 6 C charge rate.

FIG. 17 includes photomicrographs of a cross-section (top) and separator-side face (bottom) of control anodes and patterned anodes after one hundred 4 C charge cycles at −10° C.

FIG. 18 includes photomicrographs of a cross-section (top) and separator-side face (bottom) of coated anodes and coated-and-patterned anodes after one hundred 4 C charge cycles at −10° C.

FIG. 19 includes photomicrographs of a cross-section (top) and separator-side face (bottom) of control anodes and patterned anodes after one hundred 6 C charge cycles at −10° C.

FIG. 20 includes photomicrographs of a cross-section (top) and separator-side face (bottom) of coated anodes and coated-and-patterned anodes after one hundred 6 C charge cycles at −10° C.

FIG. 21 includes optical images (top row) of the separator side of control anodes, patterned anodes, coated anodes, and coated-and-patterned anodes after 6 C charging at −10° C., along with SEM photomicrographs (second and third rows) of their respective cross-sections.

FIG. 22 is a schematic of an equivalent circuit model used to decouple contributions to total electrode impedance.

FIG. 23 includes impedance spectra collected at different temperatures during charging of the cells including control anodes, patterned anodes, coated anodes, and coated-and-patterned anodes.

FIG. 24 illustrates impedance contributions at a first plateau at two different temperatures for cells including control anodes, patterned anodes, coated anodes, and coated-and-patterned anodes.

FIG. 25 illustrates impedance contributions at a third plateau at two different temperatures for cells including control anodes, patterned anodes, coated anodes, and coated-and-patterned anodes.

### DESCRIPTION OF EMBODIMENTS

Described below is a patterned and coated electrode, a lithium-ion battery including the electrode, and related methods. While presented below in the context of a graphite or graphite-based negative electrode, it should be understood that these teachings may apply to other electrode materials—particularly other electrochemically active lithium host materials with which lithium ions exhibit intercalation behavior. During patterning, microscale channels are formed in the electrode material to promote Li-ion transport to the interior of the electrode during charging. The coating may be a nanoscale conformal coating that acts as an artificial solid electrolyte interphase (SEI) in place of the SEI that is typically formed during initial charge cycles of a Li-ion battery. The coating may be selected to have a lower impedance than a naturally formed SEI and can be formed in a more controlled manner prior to cell assembly. As used herein “microscale” refers to a feature having a largest dimension of less than 500 μm, and “nanoscale” refers to a feature having a largest dimension of less than 500 nm.

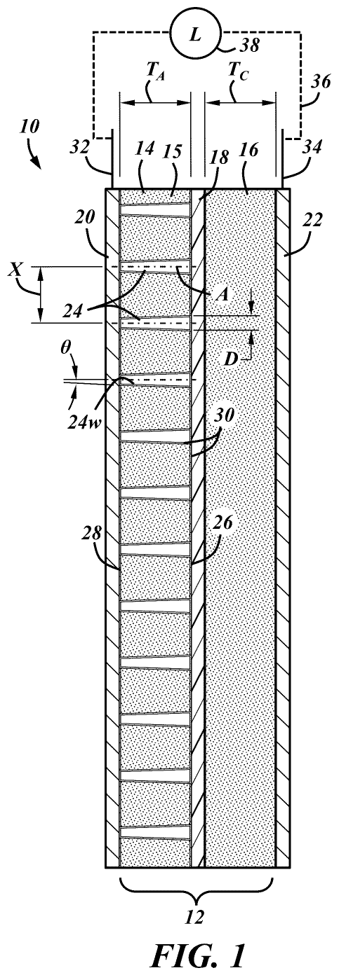

FIG. 1 is a schematic cross-sectional view of a portion of a Li-ion battery 10 that includes one or more electrochemical battery unit cells 12. A single unit cell 12 is shown here for purposes of simplicity, but it should be understood that the battery 10 may include multiple unit cells 12 electrically interconnected to achieve desired capacity, power, and/or voltage characteristics. The battery 10 of FIG. 1 has a monopolar battery architecture, but these teachings are applicable to bipolar and other battery architectures.

The illustrated unit cell 12 includes a negative electrode 14, a positive electrode 16, and a porous separator 18. The negative electrode 14 serves as the anode during cell discharge, and the positive electrode serves as the cathode during cell discharge. Hereinafter, the negative electrode 14 may be referred to as the anode, and the positive electrode 16 may be referred to as the cathode. The separator 18 physically separates and electrically isolates the electrodes 14, 16 from each other while permitting lithium ion transport between the electrodes via a liquid electrolyte infiltrating the pores of the separator and the electrodes 14, 16. The anode 14 is carried on an anode-side metal current collector 20 (e.g., a copper foil), and the cathode 16 is carried on a cathode-side metal current collector 22 (e.g., an aluminum foil). Multiple unit cells 12 may be stacked so that each anode-side current collector 20 is interposed between the anodes 14 of adjacent unit cells and each cathode-side current collector 22 is interposed between the cathodes 16 of adjacent unit cells 12.

As discussed further below, the anode 14 includes an anode body 15 that may be formed from a graphite-based anode material, and one or more channels 24 may be formed in the anode body 15 between a first face 26 of the anode and an opposite second face 28 of the anode to enhance ion transport and diffusion with respect to the anode. Additionally, one or more surfaces of the anode body 15 may have an applied coating 30 to enhance charging performance.

Each current collector 20, 22 contacts the respective electrode 14, 16 over an interfacial surface area to exchange free electrons with the electrode during charging and discharging of the battery 10. The illustrated current collectors 20, 22 include respective connection tabs 32, 34 extending away from each electrode 14, 16 that are used to electrically connect the anode 14 and the cathode 16 to an external circuit 36 that directs current flow through an external load 38 during battery discharge. During discharge, intercalated lithium is spontaneously released from the anode 14 to produce Li-ions and free electrons. The free electrons are collected by the anode-side current collector 20, routed through the external load 38 via the external circuit 36, and eventually delivered to the cathode-side current collector 22. At the same time, the Li-ions released at the anode 14 migrate through the separator 18 and into the cathode 16, where they accept available free electrons and become stored in the cathode 16 as intercalated lithium. This electrochemical process is reversed during charging of the battery 10 when the battery is connected to a power source that applies a suitable voltage in place of the external load 38.

The cathode 16 comprises a lithium-based active material that stores intercalated lithium at a higher electrochemical potential (relative to a common reference electrode) than the anode 14. Examples of lithium-based active materials that may be present in the cathode 16 include a lithium nickel cobalt aluminum oxide or NCA (e.g., LiNi_{0.8}Co_{0.15}Al_{0.05}O₂), lithium cobalt oxide (LiCoO₂), spinel lithium manganese oxide (LiMn₂O₄), a lithium nickel-manganese-cobalt oxide (Li(Ni_{X}Mn_{Y}Co_{Z})O₂), lithium iron phosphate (LiFePO₄), lithium iron fluorophosphate (Li₂FePO₄F), lithium nickel oxide (LiNiO₂), a lithium aluminum manganese oxide (Li_{X}Al_{Y}Mn_{1-Y}O₂), lithium vanadium oxide (LiV₂O₅), or mixtures that include two or more of the above-recited recited lithium-based active materials. The material of the cathode 16 may additionally include a polymeric binder material (e.g., PVdF, EPDM, SBR, CMC, polyacrylic acid) and a conductive fine particle diluent (e.g., carbon black) Similar to the anode 14, the cathode 16 may include a patterned array of channels 34 formed at least partially through its thickness in the same or similar manner as described below for the anode 14.

The separator 18 may include one or more porous polymer layers infiltrated with a liquid electrolyte. Examples of suitable polymers for each porous polymer layer include polyolefins, such as polyethylene (PE) (along with variations such as HDPE, LDPE, LLDPE, and UHMWPE), polypropylene (PP), or a blend of PE and PP. Each layer may be formed from the same or from different porous polymers. The liquid electrolyte preferably includes a lithium salt dissolved in a non-aqueous solvent. The lithium salt may be LiClO₄, LiAlCl₄, LiI, LiBr, LiSCN, LiBF₄, LiB(C₆H₅)₄, LiAsF₆, LiCF₃SO₃, LiN(CF₃SO₂)₂, LiPF₆, or a mixture that includes two or more of these salts. The non-aqueous solvent may be a cyclic carbonate (e.g., ethylene carbonate or propylene carbonate), an acyclic carbonate (e.g., dimethyl carbonate, diethyl carbonate, or ethylmethylcarbonate), an aliphatic carboxylic ester (e.g., methyl formate, methyl acetate, or methyl propionate), a γ-lactone (e.g., γ-butyrolactone or γ-valerolactone), an acyclic ether (e.g., 1,2-dimethoxyethane, 1,2-diethoxyethane, or ethoxymethoxyethane), a cyclic ether (e.g., tetrahydrofuran or 2-methyltetrahydrofuran), or a mixture that includes two or more of these solvents. A variation of the separator 18 that is able to separate and insulate the anode 14 from the cathode 16 while facilitating Li-ion mobility between the two electrodes 14, 16 is a solid or gel polymer electrolyte that includes a polymer layer (e.g., polyethylene oxide (PEO), polypropylene oxide (PPO), polyacrylonitrile (PAN), or polyvinylidene fluoride (PVdF)) complexed with a lithium salt or swollen with a lithium salt solution. The separator 18 may also be a solid-state separator that is formed from a glass or glass-ceramic composition modified with Li-ion conductive glass modifiers such as Li2_{S} and LiO₂.

The Li-ion battery 10 disclosed herein exhibits an enhanced fast charging capability at low temperatures due to the inclusion of the channels 24 formed in the anode 14 and the coating 30 on surfaces of the anode body 15 that suppresses, inhibits, or prevents the otherwise natural formation of a solid electrolyte interphase (SEI) on the anode 14. This combination of features provides the battery 10 with unexpectedly enhanced charging performance and charge cycling at charging rates up to 6 C and at temperatures below 0° C. without formation of lithium plating on the anode 14 while maintaining a high capacity. In some applications, the Li-ion battery 10 can be charged to drive lithium out of the cathode 16 and into the anode 14 at a C-rate of at least 2 C, and preferably at a C-rate of at least 4 C, between 4 C and 6 C, or at least 6 C with an anode loading that in some instances may be greater than 4 mAh/cm² anode.

As used herein, a feature of the battery is said to “suppress” a particular phenomenon if that feature measurably reduces the magnitude or probability of the phenomenon relative to when the feature is omitted. A feature of the battery is said to “inhibit” a particular phenomenon if that feature reduces the magnitude or probability of the phenomenon by at least 50% relative to when the feature is omitted. A feature of the battery is said to “prevent” a particular phenomenon if that feature reduces the magnitude or probability of the phenomenon by at least 90% relative to when the feature is omitted.

The anode 14 and anode body 15 include at least one electrochemically active lithium host material. In one embodiment, the lithium host material is a carbonaceous material, such as graphite, hard carbon, or a blend of graphite and hard carbon. In other embodiments, the electrochemically active lithium host material comprises silicon or is a blend of silicon and a carbonaceous material, such as a blend of silicon and graphite. Other electrochemically active lithium host materials, such as lithium titanate and lithium niobate, may also be included in the anode 14. The anode 14 may include graphite as the only electrochemically active lithium host material, or the anode 14 may be a composite or hybrid anode that includes a blend of graphite and hard carbon or graphite and silicon. The anode material that forms the anode body 15 may include the electrochemically active lithium host material(s) intermingled with a binder material (e.g., a polymeric binder) and/or a conductive fine particle diluent (e.g., carbon black). Suitable polymeric binders include polyvinylidene fluoride (PVdF), an ethylene propylene diene monomer (EPDM) rubber, styrene butadiene rubber (SBR), a carboxymethyl cellulose (CMC), polyacrylic acid, and mixtures thereof. The anode material may be consolidated to form the anode body 15 in a calendering operation, for example, in which heat and pressure binds the anode material together as a material layer having a uniform thickness TA. As used herein, a “graphite-based” material is a material having a graphite content of at least 50%.

Graphite is a crystalline form of carbon having covalent hexagonal rings of carbon atoms arranged in layered horizontal sheets. Lithium ions can be inserted between these layers of sheets. In various embodiments, the anode 14 and anode material includes graphite having a purity of greater than 99%, greater than 99.5%, or greater than 99.98%. The graphite may include graphite particles that exhibit an ellipsoidal shape and have a particle size distribution in which at least 90%, or at least 95%, of the graphite particles have a largest dimension in a range from 5 μm to 25 μm or, more narrowly, in a range from 5 μm to 15 μm. These levels of purity and/or particle size distribution may be applicable to other carbonaceous and non-carbonaceous lithium host materials as well.

Hard carbon is a non-graphitizable carbonaceous material that exhibits a disordered molecular structure and cannot be transformed into graphite even when heat-treated at a temperature (e.g., 3000° C.) that would transform soft carbon back into graphite. Hard carbon consists of randomly oriented small crystallites. Lithium ions can be inserted between the small crystallites as well as between the micropores surrounded by these crystallites in the hard carbon structure. One example of a hard carbon suitable for inclusion in the anode material is petroleum coke. A blend of graphite and hard carbon can provide the anode 14 with advantages of both materials, including the high reversible capacity of graphite and the relatively high charge rate capability of hard carbon. Such a blend may be tailored to attain an optimal composition that balances charge capacity and charge rate performance. In various embodiments, the electrochemically active lithium host material of the anode 14 is a blend of graphite and hard carbon in which the amount of graphite is in a range from 20% to 80% by weight and the amount of hard carbon is in a range from 20% to 80% by weight. The ratio of graphite to hard carbon in the carbonaceous material may be in a range from 20:80 to 80:20 or, more narrowly, in a range from 25:75 to 75:25.

As illustrated in FIG. 1, a plurality of channels 24 may be provided that extend at least partially through the thickness TA of the anode 14 from the first face 26 that lies adjacent the separator 18 toward the opposite second face 28 that lies adjacent the anode-side current collector 20. The at least one carbonaceous electrochemically active lithium host material is distributed throughout the bulk of the anode 14 between the opposite first and second faces 26, 28 of the anode. In the example of FIG. 1, each channel 24 is an open, non-tortuous column that extends along a centerline or axis A, and each channel is open at least at the face 26 of the anode opposing the separator 18. As shown here, each of the plurality of channels 24 may extend entirely through the thickness TA of the anode 14 and be open at both opposite faces 26, 28 of the anode. The channels 24 serve as linear pathways for rapid ionic diffusion through the thickness TA of the anode 14, which allows for a more homogeneous flux of lithium ions throughout the volume of the material of the anode 14, improves through-plane transport, and decreases ionic concentration gradients in comparison to the tortuous and slow diffusion paths in conventional anode structures. As such, the channels 24 can help improve the accessible capacity of the anode 14, thereby lowering the propensity for Li plating on the anode 14 during fast charging of the battery 10.

The plurality of channels 24 may be formed in the anode 14 by laser ablation following consolidation of the anode material to form the anode body 15, although other techniques for forming the channels 24 are certainly possible. The geometry, diameter, orientation, and inter-channel spacing may be designed and/or tuned to achieve improved cycling performance of the Li-ion battery 10. Each channel 24 may have a largest dimension measured perpendicular to the centerline A—i.e., the diameter D in the example of FIG. 1—in a range from 5 μm to 100 μm or, more narrowly, from 5 μm to 50 μm. Each channel 24 may be spaced apart from another channel by a distance X in a range from 10 μm to 200 μm, as measured between respective centerlines A of the channels 24. The channels 24 may be patterned along a face 26, 28 of the anode as an array of channels. An array includes one or more rows or columns of at least two channels 24. The array may include a uniform pattern of channels 24, meaning that the inter-channel spacing among channels is repeated in the array. One suitable uniform pattern is a close-packed hexagonal pattern in which the centerline A of each channel 24 is at the vertex of a regular hexagon such that the distance X between one channel and any other adjacent channel is the same along an entire face of the anode 14.

The lithium host material(s) included in the anode 14 and the patterning of channels 24 in the anode 14 can improve the performance of the anode 14 by improving rate capability without detrimentally sacrificing reversible capacity. When the lithium host material is of high purity and has a narrow particle size distribution as described above, such as graphite having a purity of greater than 99% and an ellipsoidal particle size in a range from 5 μm to 15 μm, laser ablation is more likely to form clean and well-defined channels 24 without producing more than a negligible amount of debris and residual particles due to sublimation of entire particles of the host material during ablation rather than cutting through particles. The parameters of the laser (e.g., laser power, wavelength, repetition rate, pulse duration, number of pulses) can be tuned to help in this regard. Formation of debris-free channels 24 can improve the overall electrochemical performance of the anode 14 and the battery 10.

As shown in FIG. 1, one or more of the channels 24 may be tapered inward toward the second face 28 of the anode 14 such that a cross-sectional area of the channel 24 decreases in a direction from the first face 26 of the anode, confronting the separator 18, toward the second face 28 of the anode 14, confronting the current collector 20. This is the direction the lithium ions are transported through the separator 18 during charging. The slope of the taper may be defined by a channel taper angle θ, which is the angle of a sidewall 24w of the channel 24 relative to the centerline A of the channel 24. The taper angle θ of each channel 24 may be in a range from 0.5 to 20 degrees, which can be varied by tuning laser parameters, focal point, and optics alignment. The taper angle θ can be tuned to optimize the fast-charging performance of the anode 14. Specifically, the taper angle θ directly affects the amount of through-plane ionic current flow through the channel 24. A slight taper angle greater than 0 and up to 20 degrees can alleviate the ionic current near the separator 18 in the Li-ion battery 10 to a larger cross-sectional area and thus reduce the local current density flowing through the channel 24, thereby improving fast-charging performance.

The patterned channels 24 also permit a lower N/P ratio for the unit cell 12, which is the ratio between the thickness T_{A} of the anode 14 and the thickness T_{C} of the cathode 16. Conventionally, an N/P ratio between 1.1 and 1.3 is used to help avoid overcharge and Li plating of the anode 14. For instance, during fast charging a conventional anode—i.e., without the channels 24 of FIG. 1—lithium plating of the anodes becomes thermodynamically favorable due to the inhomogeneous concentration gradients that are formed. Formation of Li plating is highly irreversible and thus results in significant capacity fade and the eventual failure of the cell. The arrayed patterning of the anode 14 counters these problems by improving Li-ion transport during charging, which helps avoid Li plating even at high charge rates and also creates a more homogeneous concentration throughout the anode volume. As a result, an N/P ratio of less than 1.1 is possible, which can further improve the overall energy density of the battery.

Patterning of the of channels 24 throughout the anode 14 also enables good rate capability or fast charging of thicker anodes. The channels 24 formed fully or partially through the thickness T_{A} and patterned along the entire first face 26 of the anode 14 create diffusion paths for rapid ionic transport, thus leading to more homogeneous Li-ion concentration and electrochemical reaction rates throughout the anode. In other words, the channels provide free movement of lithium ions past the plane of the first face 26 of the anode, and the channel walls 24w provide additional surface area along which Li-ion diffusion into the anode material to form intercalated lithium is available. This additional surface area is distributed through the thickness T_{A} of the anode, thus providing better access to the lithium host material throughout its volume. As a result, fast charging at 4 C to 6 C is possible with the thickness T_{A} of the anode 14 as high as 150 μm(>4.3 mAh/cm² anode loading). The thickness T_{A} of the anode 14 may thus be in a range from 25 μm to 150 μm or, more narrowly from 50 μm to 150 μm, from 75 μm to 150 μm, or from 100 μm to 150 μm.

The areal charge capacity of the anode is an indirect indicator of electrode thickness for a given electrode material, representing the theoretical volumetric charge capacity of the electrode material normalized by facial area of the electrode (as part of a battery). The examples disclosed herein are applicable to anodes having an areal charge capacity of at least 3 mAh/cm².

Following formation of the channels 24, the coating 30 may be disposed over or on one or more surfaces of the patterned anode body 15. The coating 30 may be selected to prevent a naturally formed SEI layer from forming when the newly assembled Li-ion cell 12 is subjected to its initial charge-discharge cycle. The SEI that is typically formed on the negative electrode of a Li-ion cell having a graphite-based anode and a liquid electrolyte is referred to herein as a “naturally formed” SEI. The naturally formed SEI is formed on the anode during the initial battery cycle as a reaction product of the graphite-based anode material and the electrolyte—primarily via reduction of the electrolyte. The naturally formed SEI serves an important function in that it permits Li ion transport between the electrolyte and the underlying anode material while preventing further electrolyte decomposition. As such, the coating 30 may be selected to not only prevent the naturally formed SEI from forming during initial battery cycling, but also to permit Li transport and prevent reduction of the liquid electrolyte. Also, the coating 30 can be selected to have an impedance that is lower than that of a naturally formed SEI layer such that charge transfer resistance through the coating is reduced compared to a naturally formed SEI layer.

The coating 30 may thus be referred to as an “artificial” SEI that performs the same or similar functions as a naturally formed SEI, only with better charge transport during cell charging. In addition to the composition of the coating 30 being different from that of a naturally formed SEI, the coating 30 may be more uniform in thickness and microstructure than a naturally formed SEI by virtue of its formation under controlled conditions before the anode 14 is assembled into the battery cell 12. A naturally formed SEI is formed in situ in a battery cell under inherently non-uniform conditions—i.e., it is the product of an electrochemical reaction in an environment with electrochemical gradients, making the uniformity of the natural SEI somewhat unpredictable. The coating 30 of the anode 14 described herein may be produced as a conformal coating using a coating technique that is not line-of-sight in nature, is self-limiting, and is therefore uniform. The preferred method of forming the artificial SEI coating 30 is via atomic layer deposition (ALD). ALD can deposit a nanoscale coating uniformly along all exposed surfaces of the substrate being coated.

One suitable artificial SEI coating 30 that can be formed via ALD is lithium borate-carbonate (LBCO or Li₃BO₃—Li₂CO₃); although, now armed with the unexpected results presented herein in relation to artificial SEI materials and their potential for superior fast charge performance at low temperatures-particularly when combined with the above-described patterned channels 24—other artificial SEI materials are contemplated.

An ALD process capable of forming a suitable coating 30 may include the sequential steps of exposing the electrode body 15 to a lithium-containing precursor to modify the surface of the electrode material, then exposing the modified surface to an oxygen-containing precursor to further modify the modified surface. These steps can be repeated from 1 to 10 times as a first subcycle of the process. A second subcycle of the process may then be performed and repeated from 1 to 10 times in which the modified surface is exposed to a boron-containing precursor, and then to the same or a different oxygen-containing precursor. Each step of each subcycle may occur in either order and at a temperature between 50° C. and 280° C., or between 180° C. and 280° C., or between 200° C. and 220° C.

The first and second subcycles together constitute a supercycle, which can be repeated between 5 and 5000 times, between 10 and 1000 times, or between 100 and 500 times, for example. The precursors may be in a gaseous state, and the first and second subcycles may occur in either order to start the supercycle. The sequential reactions can be separated either chronologically or spatially. The resulting coating 30 is a nanoscale film comprising lithium, boron, oxygen, and in some cases carbon and is ionically conductive.

The lithium-containing precursor may include or may be selected from the group consisting of: a lithium alkoxide such as lithium tert-butoxide (LiOtBu), 2,2,6,6-tetramethyl-3,5-heptanedionate (Li(thd)), or lithium hexamethyldisilazide (LiHMDS). The boron-containing precursor may include or may be selected from the group consisting of: a boron alkoxide such as triisopropylborate (TIB), boron tribromide (BBr₃), boron trichloride (BCl₃), triethylboron (TEB), tris(ethyl-methylamino) borane, trichloroborazine (TCB), tris(dimethylamido)borane (TDMAB), trimethylborate (TMB), or diboron tetrafluoride (B₂F₄). The oxygen-containing precursor may include or may be selected from the group consisting of: ozone (O₃), water (H₂O), oxygen plasma (O₂(p)), ammonium hydroxide (NH₄OH) or oxygen (O₂).

The coating 30 may have a thickness between 20 and 100 nanometers, between 0.1 and 1000 nanometers, between 1 and 100 nanometers, or between 20 and 80 nanometers. The coating may also have a total area-specific resistance (ASR) of less than 450 ohm-cm², or is less than 400 Ω-cm², or is less than 350 Ω-cm², or is less than 300 Ω-cm², or is less than 250 Ω-cm², or is less than 200 Ω-cm², or is less than 150 Ω-cm², or is less than 100 Ω-cm², or is less than 75 Ω-cm², or is less than 50 Ω-cm², or is less than 25 Ω-cm², or is less than 10 Ω-cm², or less than 5 Ω-cm².

The coating 30 may have an ionic conductivity of greater than 1.0×10⁻⁷ S/cm, or greater than 1.0×10⁻⁶ S/cm, or greater than 1.5×10⁻⁶ S/cm, or greater than 2.0×10⁻⁶ S/cm, or greater than 2.2×10⁻⁶ S/cm at standard temperature and pressure, and may have an ionic transference number of greater than 0.9999 from 0-6 volts vs. lithium metal.

In some embodiments, a coating having some combination of the above-described properties or characteristics can be formed via chemical vapor deposition (CVD) or other suitable technique.

### EXPERIMENTAL EXAMPLE

Pouch cells were fabricated with four different types of graphite-based electrodes, including highly ordered laser-patterned electrodes (HOLE) with patterned channels 24 but no coating 30, planar electrodes including the coating 30 but no patterned channels 24 (LBCO), electrodes with both patterned channels 24 and the coating 30 (LBCO-HOLE), and electrodes with neither patterned channels 24 nor the coating 30 (Control).

The electrode bodies were fabricated using pilot scale roll-to-roll battery manufacturing equipment. For the anodes, natural graphite (battery grade, SLC1506T, Superior Graphite, Chicago, IL USA) was mixed with C65 conductive additive (i.e., carbon black) and binder material at a 94:1:5 ratio by weight. The binder material included carboxymethyl cellulose (CMC) and styrene-butane rubber (SBR). The resulting slurry was cast onto 10 μm thick copper foils as the anode-side current collector. The graphite loading was 9.40 mg/cm² with a theoretical capacity of 3.18 mAh/cm². After casting, each graphite anode was dried and calendered to 32% porosity. For the cathodes, lithium nickel-manganese-cobalt oxide (LiNi_{0.5}Mn_{0.3}Co_{0.2}O₂, battery grade, NMC-532, Toda America, Battle Creek, MI USA) was mixed with C65 conducting additive, and PVDF binder at a 92:4:4 ratio by weight. The resulting slurry was then cast onto 15 μm thick aluminum foils as the cathode-side current collector and calendered to 35% porosity. The NMC loading was 16.58 mg/cm². The N/P ratio for the fabricated anodes and cathodes was 1.2.

A pulsed laser source (Matrix 355-8-50, Coherent, Santa Clara, CA USA), galvo-scanning optics system (Thorlabs, Newton, NJ USA), and data acquisition card (National Instruments, Austin, TX USA) were used to pattern microscale channels through the thickness of post-calendered anodes for the HOLE and LBCO-HOLE samples. The laser source was operated at 8 Watts and 355 nm wavelength with a repetition rate of 50 kHz and a pulse duration of 10 ns. The channels were formed in the face of the anode opposite the face confronting the current collector in close-packed hexagonal arrays at a channel diameter of approximately 40 μm with an 85 μm center-to-center inter-channel spacing to form the HOLE anodes.

For the LBCO and LBCO-HOLE anodes, the coating was formed via atomic layer deposition (ALD) using a Savannah S200 ALD station (Veeco, Waltham, MA USA). HOLE anodes were coated to form the LBCO-HOLE samples, and anodes without patterned channels were used to form the LBCO samples. All depositions were performed at a substrate temperature of 175° C. LBCO was deposited using a supercycle approach with lithium tert-butoxide (LiOtBu), triisopropyl borate (TIB), and ozone (O₃) precursors. One supercycle included, sequentially, exposure of the respective anode body to LiOtBu, an argon (Ar) purge, exposure to O₃, an Ar purge, exposure to TIB, exposure to O₃, and another Ar purge. 250 supercycles were conducted on each LBCO and LBCO anode body, which corresponds to a coating thickness of approximately 25 nm. LBCO thickness for 250 supercycles was measured as deposited on a silicon wafer using spectroscopic ellipsometry. The base pressure of the system was 680 mTorr at 10 sccm.

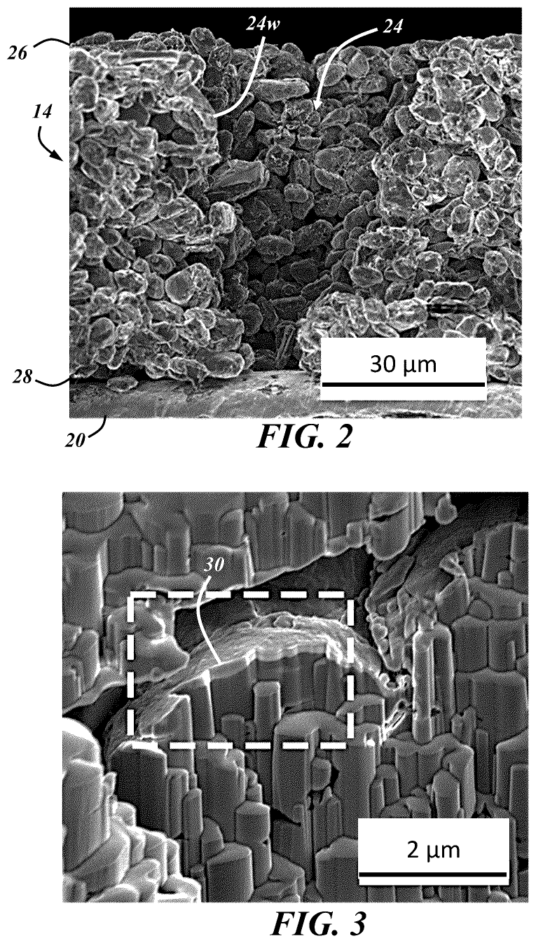

Scanning electron microscopy (SEM), energy-dispersive spectroscopy (EDS), and X-ray photoelectron spectroscopy (XPS) were used to observe the morphology and conformality of the ALD coating after laser patterning on the LBCO-HOLE samples. Focused ion beam (FIB) milling was used to cut the coated graphite particles. FIG. 2 is an SEM photomicrograph of a cross-section of a coated LBCO-HOLE anode 14 taken along one of the patterned channels 24 with the first face 26 of the anode facing up and the second face 28 confronting the anode-side current collector 20.

FIG. 3 is an enlarged view of a portion of the coated anode material from FIG. 2, in which a graphite particle has been cut through. Here, the graphite appears as vertical columnar structures and the LBCO coating 30 appears as a relatively thin and lighter colored shell on a graphite particle. These figures indicate that ALD was successful in coating the graphite particles located along the channel walls 24w and that the coating is a conformal coating.

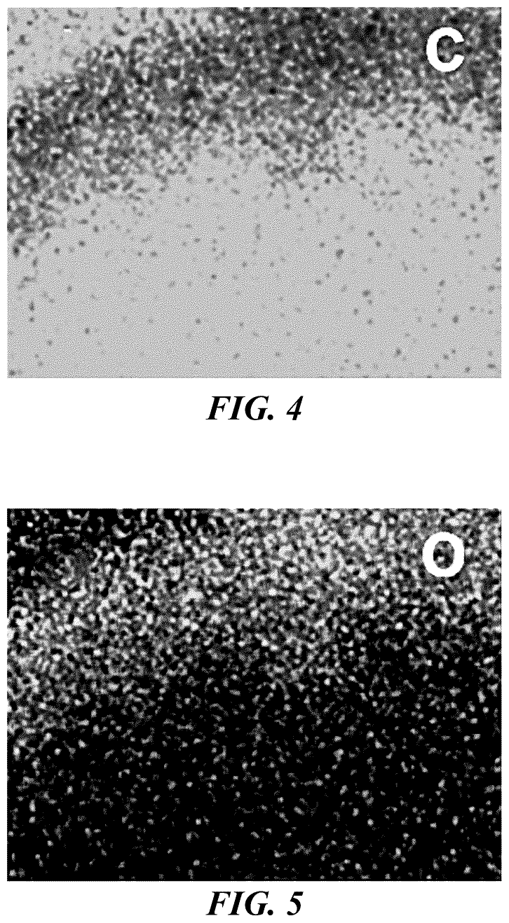

EDS elemental mapping of carbon (C) and oxygen (O) is illustrated respectively in FIGS. 4 and 5 for the portion of FIG. 3 outlined with a broken rectangle. The arc-shaped swath of contrasting shade in FIGS. 4 and 5 corresponds to the coating 30 of FIG. 3, where the lighter shade indicates the presence of the clement being mapped and the dark shade indicates the absence of the element being mapped. Here, the area corresponding to the coating 30 is characterized by the absence of carbon and by the presence of oxygen, which is consistent with the composition of an LBCO coating. The peak positions from XPS spectra of the coating were found to match those of a glassy LBCO phase. The XPS system (Kratos Axis Ultra with monochromated Al Kα source) was directly connected to an Ar glovebox to avoid exposure of the samples to air. XPS data was analyzed with CasaXPS (Casa Software Ltd.).

Electrodes having facial dimensions of 7×10 centimeters were punched and assembled into pouch cells in a dry room (<40° C. dewpoint). A 12 μm thick polymer separator (ENTEK International LLC) was used between each anode and cathode. The liquid electrolyte was 1M LiPF₆ in 3:7 ethylene carbonate (EC)/ethylmethyl carbonate (EMC) with 2 wt % vinylene carbonate (VC) (Soulbrain, MI USA). After cell assembly, each pouch cell was preconditioned with two C/10 constant current cycles at 30° C. for cell formation, then degassed in a dry room and rescaled for the subsequent electrochemical tests.

To evaluate electrochemical performance of the cells under different conditions, the pouch cells were cycled using a Maccor 4000 series system (Maccor Inc., Tulsa, OK USA) with a CC-CV protocol and a charge time cutoff. The cells were first charged at a constant current (CC) until reaching an upper voltage cutoff of 4.15 V, then charged at a constant 4.15 V voltage (CV) for a total charge time of 1/(C-rate) hours—e.g., 15 minutes for 4 C charging, and 10 minutes for 6 C charging, including both the CC and CV portions. The discharge protocol was also CC-CV, where the cells were first discharged at a constant 0.33 C rate, followed by a constant voltage discharge at 3.0 V until the current reached a value of 0.05 C, at which time the cells are considered fully discharged. The rest time after each charge-discharge cycle was 5 minutes. Each cell was subjected to 100 charge-discharge cycles at 4 C and 6 C charge rates and three different temperatures: 30° C., 5° C., and −10° C. At the beginning, and at every 50 cycles, the cells were charged and discharged at a 0.33 C rate until 0.05 C current cutoff for 3 cycles to check the state-of-health of the cells. These “health checks” at a low charge rate are indicative of the cells' remaining capacity and, conversely, their permanent loss of charge capacity. For example, if after 100 fast-charge cycles, low C-rate charging brings a cell to 95% of its initial capacity, it can be deduced that the cell has permanently lost 5% of its capacity.

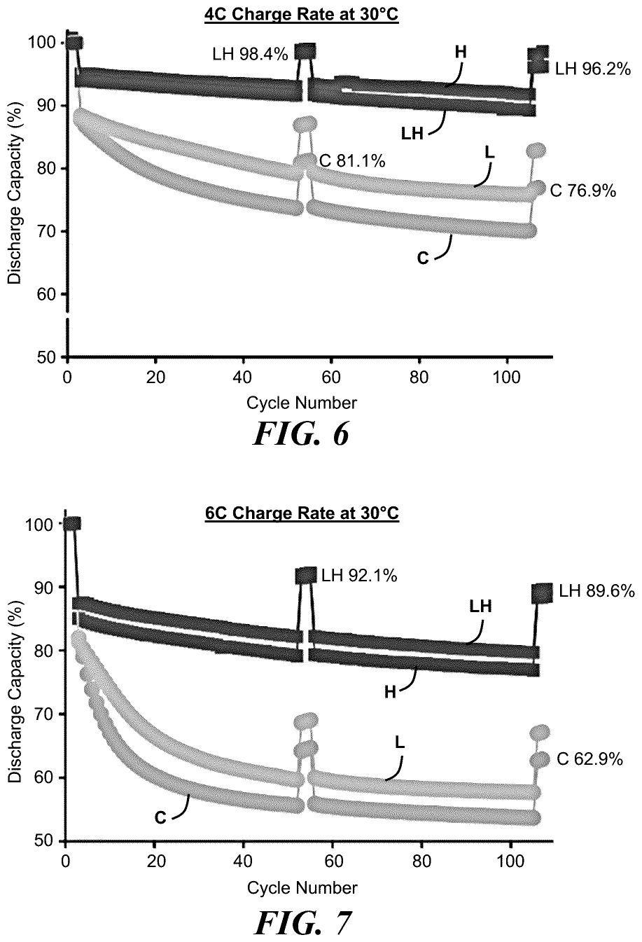

FIGS. 6-11 illustrate the state-of-charge (SOC) of cells with the four different anode configurations at both charge rates at all three temperatures. Each data point in these figures represents the state of charge of the respective cell after the charge portion of each charge cycle. The smooth portion of each curve represents data points collected after a fast charge cycle, while the locally increased values near 50 and 100 cycles represent the above-described “health checks.”

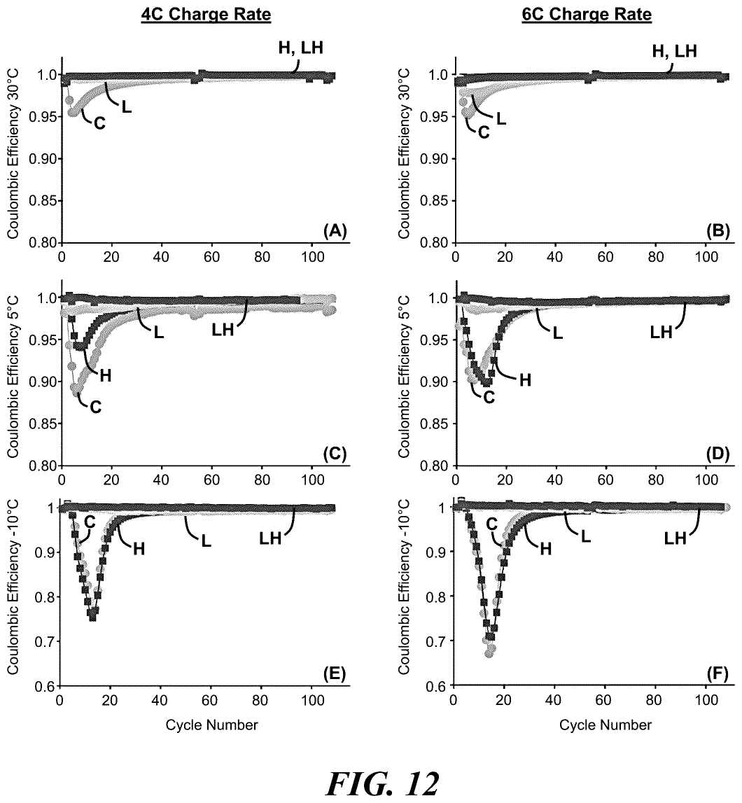

The pouch cells were first cycled at 1 C, 4 C, and 6 C rates at 30° C. to compare the electrochemical performance of the four different anode constructions at or near normal operating temperatures. At 1 C cycling (not illustrated), all cells exhibited stable cycling, as expected. But, as illustrated in FIGS. 6 and 7, the cells with the Control anodes (labeled “C” in the figures) experienced significant capacity fade at 4 C and 6 C charge rates. At the 6 C charge rate, the SOC of the Control anodes rapidly decreased within the first 20 cycles before leveling out. This rapid fade in the initial cycles of the Control cell corresponds to a dip in the Coulombic efficiency (see FIG. 12B), which is a result of lithium plating on the anode, as confirmed and discussed further below. This irreversible formation of Li-metal depletes available Li from the active reservoir. The driving force for additional Li plating is thereby reduced with the loss of Li inventory, and cell SOC after saturation of Li plating then approaches a plateau value. As shown in FIGS. 12A-12B, the Coulombic efficiency (CE) of the Control cells experiences a dip at less than 10 cycles. After the CE reaches a plateau value near cycle 50, Control cell SOC is below 75% at the 4 C charge rate (FIG. 6) and below 60% at the 6 C charge rate (FIG. 7).

At the last of the 100 cycles of 30° C. fast charging, the Control cells reached only a 70% SOC at the 4 C and under 55% at 6 C charge rate. The health checks after 100 4 C and 6 C fast charge cycles indicate a permanent loss of charge capacity of 23% and 37%, respectively. In other words, the maximum state-of-charge each of those cells can achieve after having been subjected to the 100 fast charge cycles is 77% and 63%, even at slow charge conditions.

The final health check of the HOLE (H), LBCO (L), and LBCO-HOLE (LH) cells after 30° C. fast charging indicate that all of those cells retained over 80% of their capacity after the 4 C cycles and over 65% after the 6 C cycles. The final health checks of the HOLE (H) and LBCO-HOLE (LH) cells indicate that those cells retained over 95% of their original capacity at the 4 C charge rate and about 90% of their original capacity at the 4 C charge rate. Inclusion of the patterned channels in the anodes thus provides the most dramatic effect on capacity retention at fast-charge cycling conditions at a “normal” operating temperature of 30° C. The channels facilitate Li-ion transport into the bulk electrode material, thus reducing concentration gradients in the thickness direction of the electrode during fast charging.

While the improvements provided by the LBCO anode coating at 30° C. are only marginal, they are believed to be due, at least in part, to the presence of the coating suppressing formation of a natural SEI layer on the anode material. In place of a naturally formed SEI layer, the LBCO acts as an artificial SEI having a lower impedance. This decreased impedance can help suppress Li plating and reduce cell polarization under fast charging conditions. Although the LBCO cells (L) retained over 80% of their capacity after the 4 C cycles and over 65% after the 6 C cycles at 30° C., capacity retention was much lower than that of the HOLE (H) and LBCO-HOLE (LH) cells. This is attributed to the relative contribution from enhanced Li ion transport provided by the patterned channels in the anodes versus the lower SEI impedance provided by the LBCO coating. At 30° C., the concentration polarization due to the tortuous pathway through the planar LBCO electrodes leads to Li plating since Li needs to diffuse through the electrode material to reach the opposite face of the electrode and cannot do so fast enough. The long diffusion length exacerbates the mass transport limitation in the electrolyte. In contrast, the Coulombic efficiency of the HOLE (H) and LBCO-HOLE (LH) cells is consistent throughout the 100 cycles at 30° C. without any significant dip (see FIGS. 12A-12B). As a result, capacity retention of the HOLE (H) and LBCO-HOLE (LH) cells as indicated at the final slow charge health checks is up to 90% after 100 cycles of 6 C charging at 30° C. and greater than 96%, or even 98%, after 100 cycles of 4 C charging.

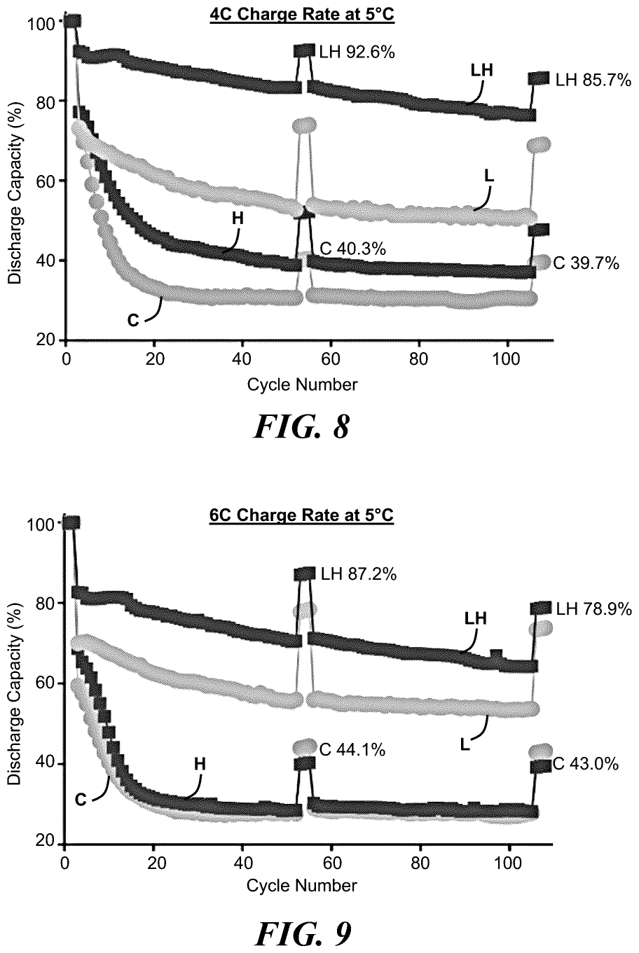

While the HOLE (H) cells outperformed the LBCO (L) cells at 30° C., the opposite was observed when the charge-discharge cycles were performed at 5° C. As illustrated in FIGS. 8 and 9, the SOC during 4 C charging and total capacity retention after 100 cycles of 4 C charging of the uncoated HOLE anodes (H) was only marginally better than that of the Control anodes (C). And the HOLE cells performed as poorly as the Control cells during and after 6 C charging. As shown in FIGS. 12C-12D, the HOLE cells (H) experience a dip in Coulombic efficiency similar to that of the Control cells (C) at 5° C., indicating Li plating on the anodes. In contrast, the LBCO cells (L) experienced only a small dip in Coulombic efficiency during rapid charging at 5° C. and retained 70-75% of their capacity at the health checks after 100 cycles. This role reversal between the patterned channels of the HOLE anodes (H) and the coating on the LBCO anodes (L) at a lowered temperature can be attributed to the resistance of the cells being dominated by charge-transfer resistance as the temperature decreases, as confirmed and discussed in more detail below.

Due to increased cell polarization at lower temperature conditions, Li plating becomes thermodynamically favorable as the anode potential decreases to below 0 V vs. Li/Li+. This results in two different reaction pathways for the current being applied to the cell, and the fractional current distribution between these reaction pathways is determined by the relative magnitudes of impedances associated with Li nucleation vs. Li+ intercalation. The high charge-transfer impedance of the naturally formed SEI on the graphite-based anode material in the Control (C) and HOLE (H) cells leads to Li nucleation on the surface in the early cycles. Once Li nucleation occurs, a new reaction pathway associated with growth of the Li metal is developed and becomes the dominant pathway due to the increase in Li surface area and the decrease in active graphite surface area, at the expense of the Li intercalation pathway. Even though the HOLE channels are available to serve as rapid ion transport pathways during fast charging, the planar surfaces of the uncoated anode are still vulnerable to initial Li nucleation. The total current associated with Li nucleation and growth increases with time and exacerbates the problem.

For the LBCO (L) and LBCO-HOLE (LH) samples, the artificial SEI layer can suppress the onset of Li plating by lowering charge-transfer impedance relative to a naturally formed SEI layer. The magnitude of the nucleation barrier plays a key role in the low temperature fast charging performance because, if Li does not nucleate on the surface, there only exists one pathway for the applied current, which is to intercalate between the graphite layers. As shown in FIG. 12C-12D, the LBCO cells (L) do not experience the significant drop in Coulombic efficiency at 5° C. that is experienced by the uncoated Control and HOLE cells. The LBCO-HOLE (LH) cells experience no noticeable drop in Coulombic efficiency at 5° C. This infers minimal Li plating on the anode surfaces. As shown in FIGS. 8 and 9, capacity retention at the cell health checks after 100 4 C and 6 C rapid charge cycles at 5° C. was between 70% and 75% for the LBCO cells and approximately 80% to 85% for the LBCO-HOLE cells.

Notably, the improvements attributed to the patterned channels of the HOLE samples (H) and to the coating of the LBCO samples (L) are not merely additive to arrive at the improvement attributed to the combination of patterned channels and coating present in the LBCO-HOLE samples (LH). This phenomenon is most noticeable in FIG. 9, which shows that the inclusion of the patterned channels alone in the HOLE cells (H) offers almost no improvement over the Control samples (C) at the 5° C. 6 C charge rate, while the inclusion of the coating alone in the LBCO cells (L) improved final capacity retention to about 73% from the 43% final capacity retention of the Control samples. Based on the absence of any improvement provided by the channels alone at the 6 C charge rate, additionally providing such channels in an LBCO-coated anode may be expected to offer little or no improvement over the LBCO cells. But FIG. 9 tells a different story. There is a synergistic effect when the patterned channels are combined with the coating, with the state-of-charge of the LBCO-HOLE cells being consistently greater than that of the LBCO (L) cells by about 10-15% during the fast charge cycles.

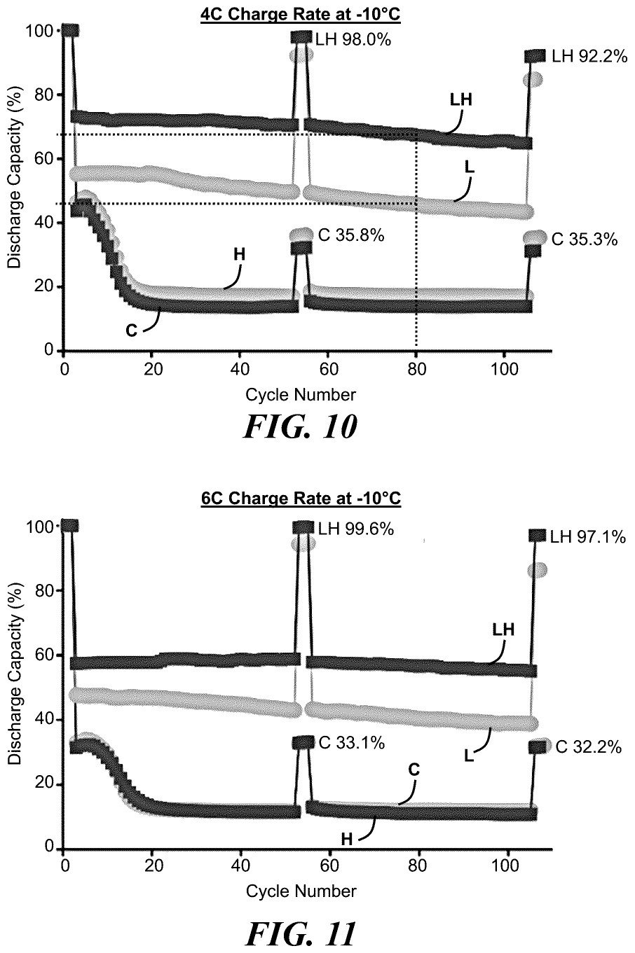

This phenomenon is even more clearly demonstrated at a cycling temperature of −10° C., as illustrated in FIGS. 10 and 11. Here again, the HOLE cells (H) performed virtually the same as the Control samples (C), with a permanent loss of approximately 65-70% of initial charge capacity after 100 cycles. Final capacity retention of the LBCO (L) cells after 100 4 C or 6 C cycles as indicated by the final health checks was approximately 85%. Final capacity retention of the LBCO-HOLE (LH) cells after 100 4 C or 6 C cycles as indicated by the final health checks was over 90% and up to 97%. As shown in FIGS. 12E and 12F, Coulombic efficiency of the LBCO (L) and LBCO-HOLE (LH) cells remains near 100% through the 100 fast charging cycles for both 4 C and 6 C charge rates at −10° C.

While total capacity retention of the LBCO (L) and LBCO-HOLE (LH) cells as measured at the 50 and 100 cycle health checks are similar, the SOC of the LBCO-HOLE (LH) cells was significantly higher than that of the LBCO (L) cells during −10° C. cycling. This is represented by the vertical distance between the curves in FIGS. 10 and 11. Stated differently, at the same duration fast-charge times, the LBCO-HOLE (LH) cells reached a higher state-of-charge than the LBCO (L) cells. Specifically, the 4 C charge rate is a 15-minute total charging time, and the LBCO-HOLE (LH) cells consistently reached a higher SOC than the LBCO (L) cells by about 20% additional SOC throughout the 100 cycles. At the 6 C charge rate, which is a 10-minute total charging time, the LBCO-HOLE (LH) cells reached an SOC from 10% to 20% higher than the LBCO (L) cells, with the difference between the two increasing from 10% to 20% over the course of the 100 cycles. As a specific example illustrated in dotted lines in FIG. 10, the LBCO (L) cell reached an SOC of approximately 45% at cycle 80, while the LBCO-HOLE cell reached an SOC of over 65% at cycle 80, both at a total charge time of 15 minutes at −10° C.

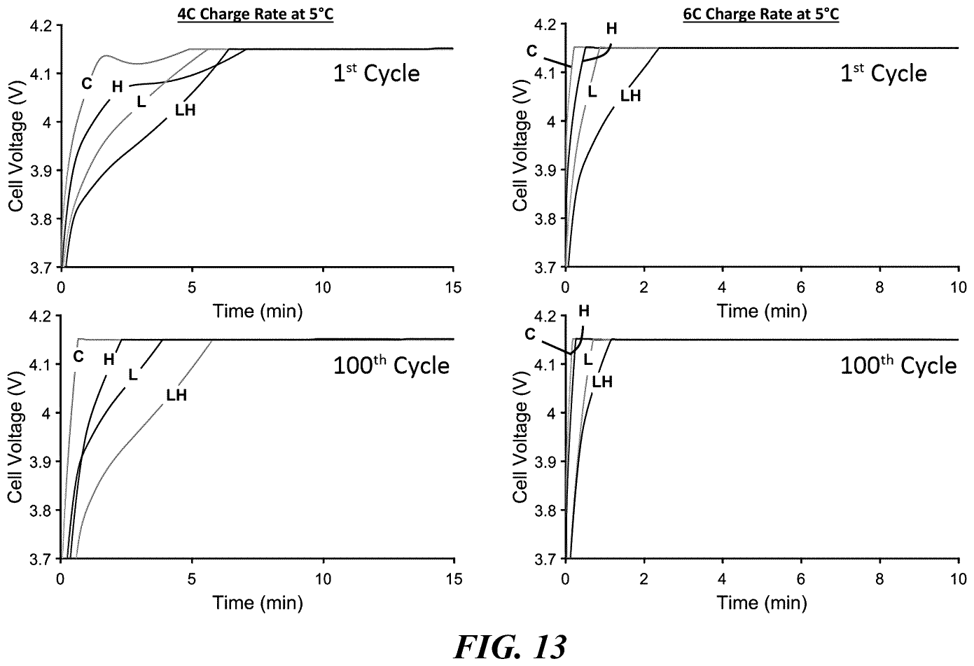

Under the CC-CV charging protocol, the cell potential reaches the cutoff voltage significantly faster at lower temperatures than at higher temperatures due to increased cell polarization at lower temperatures. By examining the voltage traces of 1st and 100th fast charge cycles, it is possible to examine cell polarization and the overpotential difference among the Control, HOLE, LBCO, and LBCO-HOLE cells. As shown in FIG. 13, the Control (C) cell voltage reaches 4.15 V in about 45 seconds at cycle 100 at the 4 C charge rate and in less than 15 seconds at the 6 C charge rate. The Hole (H) cell voltage reaches 4.15 V in about 140 seconds at cycle 100 at the 4 C charge rate and about 15 seconds at the 6 C charge rate. The LBCO (L) cell voltage reaches 4.15 V in about 4 minutes at cycle 100 at the 4 C charge rate and about 45 seconds at the 6 C charge rate. The LBCO-Hole (LH) cell voltage reaches 4.15 V in about 5.5 minutes at cycle 100 at the 4 C charge rate and about 75 seconds at the 6 C charge rate.

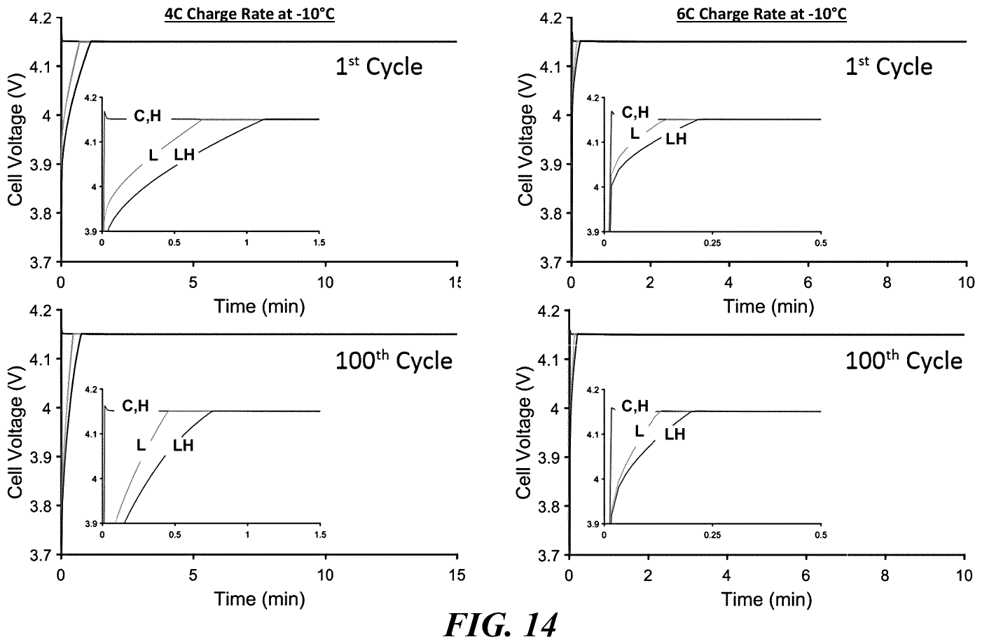

FIG. 14 illustrates the same sets of voltage traces, except at −10° C. As shown in FIG. 14, the Control (C) and HOLE (H) cell voltages reaches 4.15 V in about 1 second at cycle 100 at the 4 C charge rate and in about 0.5 seconds at the 6 C charge rate. The LBCO (L) cell voltage reaches 4.15 V in about 30 seconds at cycle 100 at the 4 C charge rate and about 8 seconds at the 6 C charge rate. The LBCO-Hole (LH) cell voltage reaches 4.15 V in about 45 second at cycle 100 at the 4 C charge rate and about 12 seconds at the 6 C charge rate.

Since the cells are over-polarized under fast charging and low temperature conditions, the CC portion of the charge cycle is significantly shortened compared to cells cycled at 30° C. This leads to a narrower SOC swing under low temperature conditions.

To observe initial intercalation vs. Li plating behavior during fast charging at low temperatures, coin cells were assembled using the four different anode constructions with NMC-532 cathodes. After pre-conditioning with two C/10 CC cycles, the coin cells were charged to 4.15 V at 6 C and at 5° C. with CC-CV protocol and a 10 minute time cut-off. After the first half-cycle (charge cycle), the cells were disassembled, and the anodes were rinsed in dimethyl carbonate (DMC) inside an Ar glovebox to minimize Li re-intercalation. All four anode constructions were then torn for optical microscopy using a VHX-7000 digital microscope (Keyence Corp.).

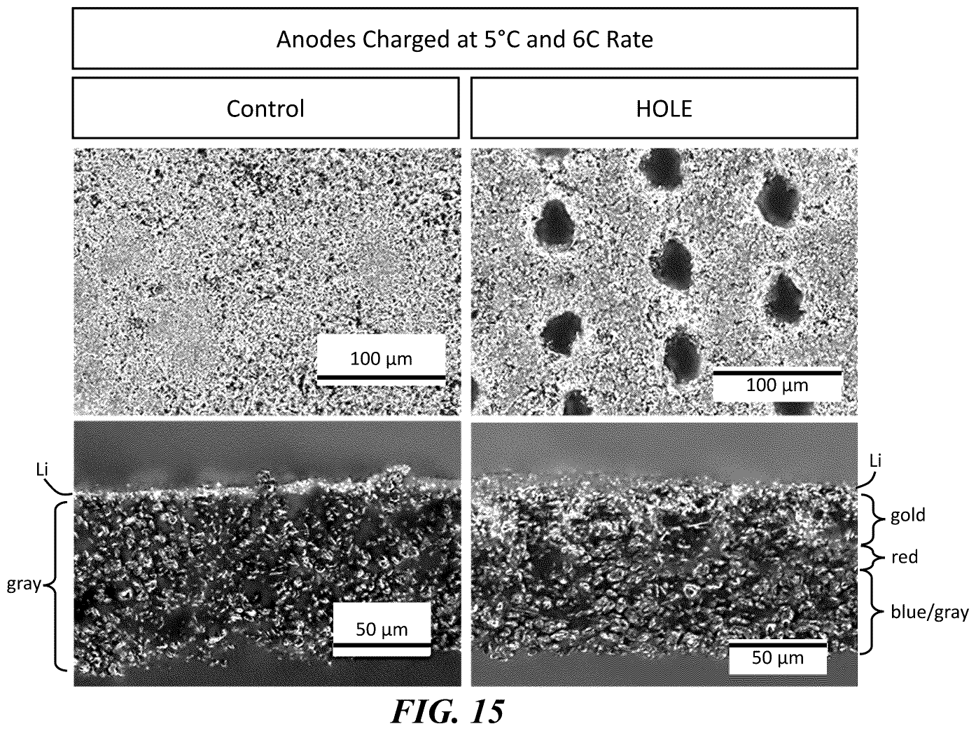

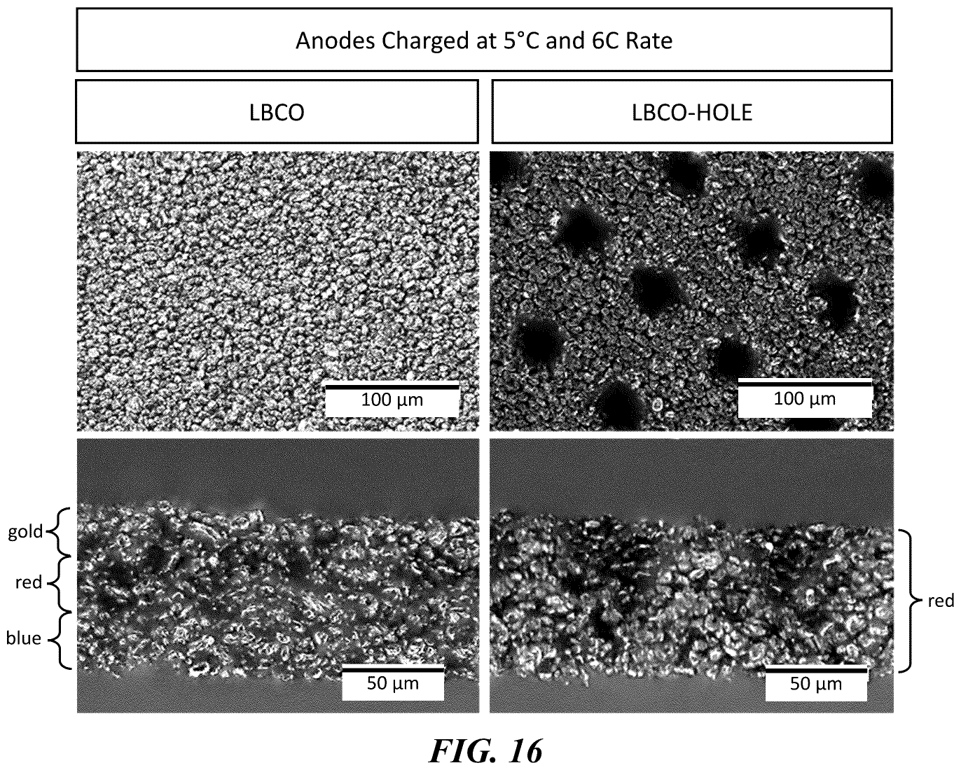

Previous work has shown that increases in graphite SOC are indicated by sequential changes in color from gray (0% SOC) to blue (LiC₁₈) to red (LiC₁₂) to gold (Li_{C6}). FIG. 15 includes photomicrographs of the separator-side face (top) and cross-section (bottom) of the Control and HOLE anodes after charging for 10 minutes at 5° C. and 6 C charge rate. FIG. 16 includes photomicrographs of the separator-side face (top) and cross-section (bottom) of the LBCO and LBCO-HOLE anodes after the same charging conditions. While the original images are color images, this disclosure necessitates black and white images. As such, the observed colors and observed Li plating are labeled in the corresponding figures for purposes of this disclosure.

As illustrated in FIG. 15, the full thickness of the Control anode remained gray after charging, and a thin continuous layer of Li plating was formed on the anode face. This indicates that a significant amount of the applied current was used to first nucleate Li on the anode surface and then to grow the Li plating layer, rather than to intercalate Li into the anode material. On the HOLE anode, some gold anode material was observed near the separator side, with some red at the middle of the anode thickness, and blue/gray near the current collector side. However, a significant amount of Li plating formed on the separator side of the anode, especially near the edges of the patterned channels, which shows up as white rings encircling the dark channels in FIG. 15.

In contrast to the uncoated control and HOLE anodes of FIG. 15, no Li plating was formed on the LBCO and LBCO-HOLE anodes of FIG. 16. The separator side of the LBCO anode is fully changed to gold, but the cross-sectional view of the LBCO anode shows that the middle portion of the anode is red, and the current collector face is blue, indicating a significant concentration gradient across the anode thickness. This indicates that, although the LBCO coating can suppress Li plating at low temperatures, Li-ion transport into the thickness of the anode is hindered by the slow kinetics of the planar (i.e., non-patterned) anode construction. In the LBCO-HOLE anode, homogenous Li intercalation was observed via red anode material across the entire anode thickness. This demonstrates that the problems of Li plating on the anode and spatial heterogeneity of Li intercalation within the thickness of the anode under low temperature, fast-charge conditions can be addressed using a combination of patterned channels and an artificial SEI on graphite-based anodes.

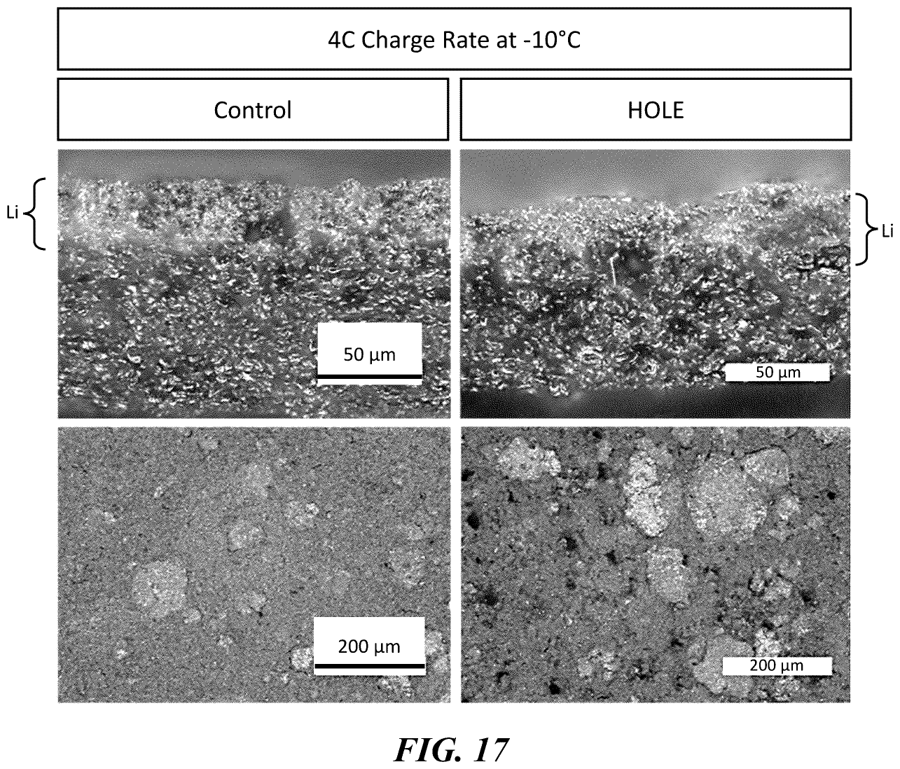

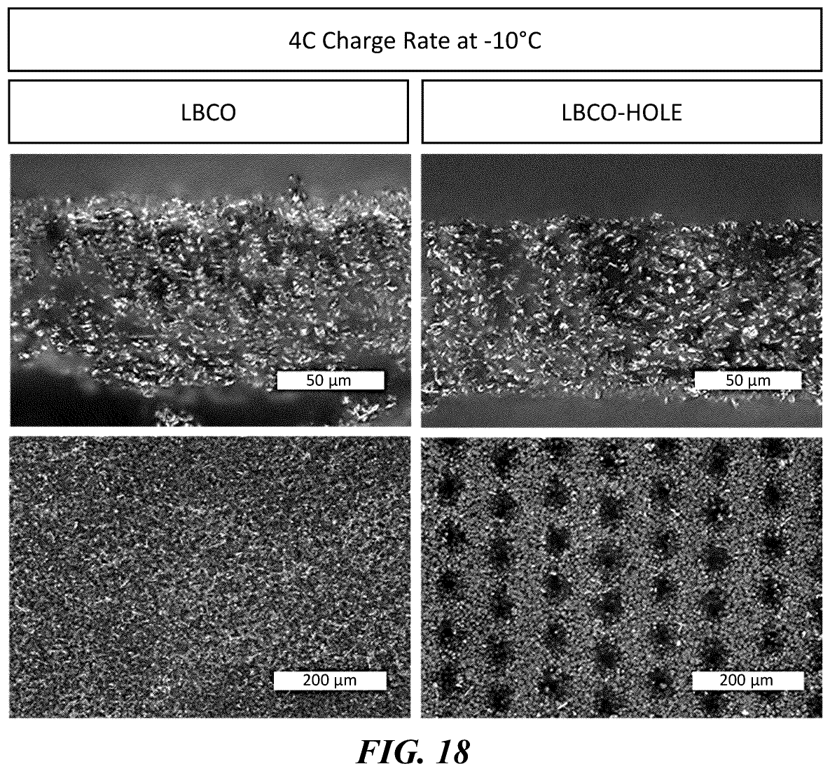

To confirm that the initial capacity fade and the capacity retention loss in the cells were a result of Li plating, the above-described pouch cells were disassembled after their respective 100 fast-charge cycles and after being fully discharged before disassembly. FIG. 17 includes photomicrographs of the cross-section (top) and separator side of the Control and HOLE anodes after 100 4 C charge cycles at −10° C., and FIG. 18 includes photomicrographs of the cross-section and separator side of the LBCO and LBCO-HOLE anodes after the same charging conditions. While the original images are color images, the observed Li plating is labeled in the corresponding grayscale figures for purposes of this disclosure.

As shown in FIG. 17, relatively thick and homogeneous Li plating was formed on the separator face of the Control and HOLE anodes. The Li deposits maintain their metallic silver luster even though the anode was fully discharged before cell disassembly. This confirms that the Li plating is inactive Li. This irreversible formation of Li metal represents permanent loss of accessible (ionizable) Li in the cell, resulting in the observed capacity fade. Once Li began nucleating on the HOLE anode surface, Li islands continued to grow until it Li metal fully blocked the patterned channels, as shown in FIG. 17. As demonstrated above, the HOLE anodes were able to fast-charge without Li plating forming at 30° C. thanks to freer ion transport and a more uniform concentration of Li ions through the anode thickness. But, as evidenced in FIG. 17, the high cell polarization during fast charging of the uncoated HOLE cells at lower temperatures causes Li plating to form and eventually block the patterned channels, practically eliminating the benefits of the patterned channels as discussed above in conjunction with FIGS. 8-11.

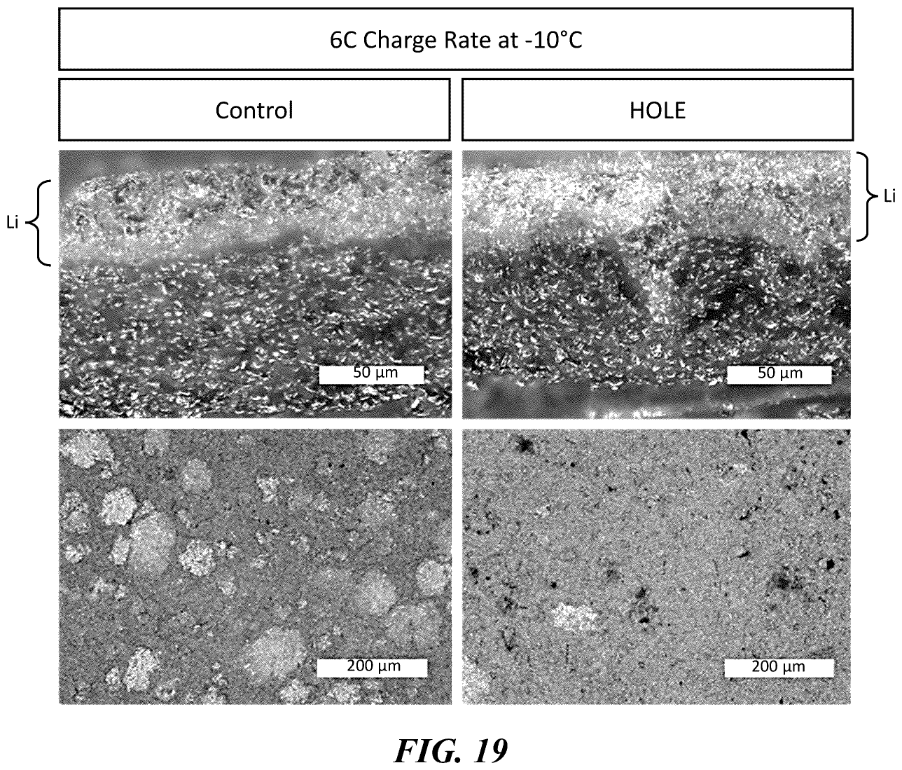

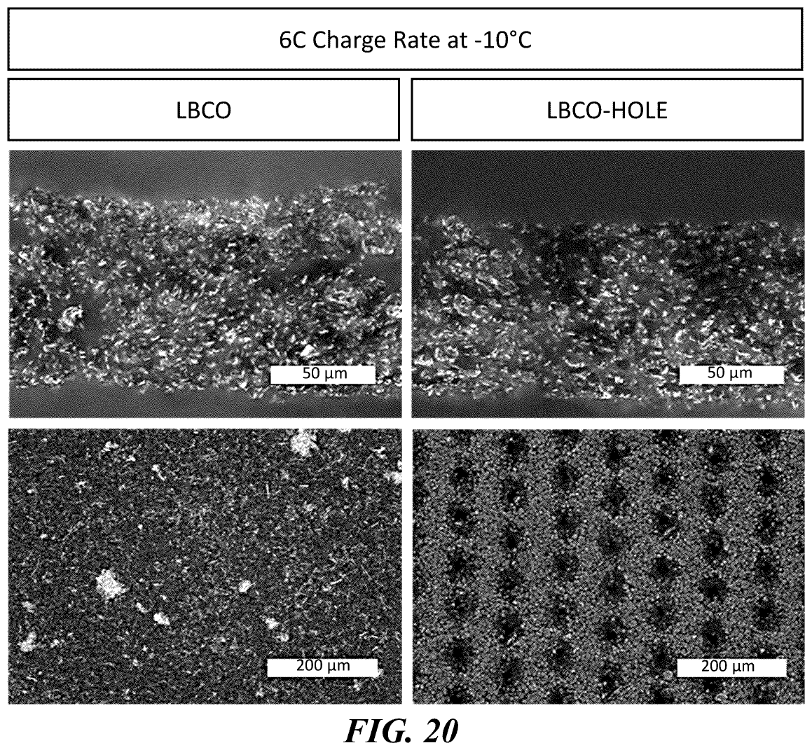

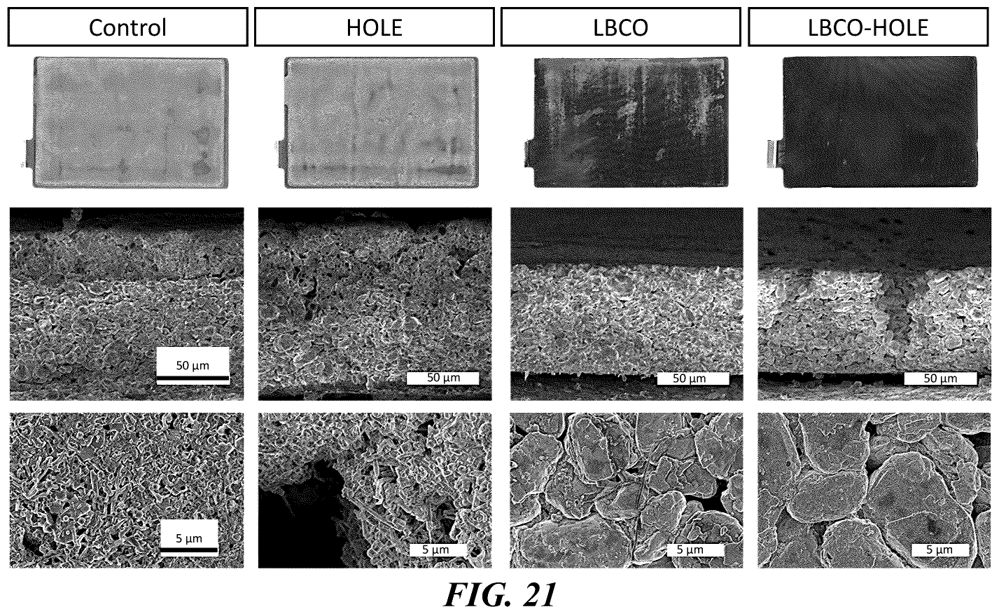

In contrast, only trace amounts of Li metal were observed on the LBCO and LBCO-HOLE anodes cycled under the same conditions, as illustrated in FIG. 18. Similar results were obtained at 6 C charge rates at −10° C., as illustrated in FIGS. 19 and 20, where the Li plating is apparent within the thickness in the patterned channels of the HOLE anode. A small amount of Li metal is present on the separator side of the LBCO anode at the 6 C charge rate, while the face of the LBCO-HOLE anode is substantially free from Li plating. As used here, “substantially free from” means that Li plating was “prevented,” as defined above. This is also illustrated in FIG. 21, which includes optical images (top row) of the separator side of the four different electrode configurations after 6 C charging at −10° C., along with SEM photomicrographs of their respective cross-sections.

To further investigate the impact of the artificial SEI coating on the graphite-based anode material, a three-electrode single layer pouch cell with an integrated Li metal reference electrode was used to monitor anode potential during fast charging at 5° C. Consistent with the results above, the voltage curves were substantially different between the Control, HOLE, LBCO, and LBCO-HOLE cells. The LBCO and LBCO-HOLE electrode potential decreased slower than that of the Control and HOLE electrode, and no local minimum is observed within the duration of the CC fast charging of the LBCO and LBCO-HOLE cells. Since Li plating can only occur when the electrode potential drops below 0 V versus Li/Li+, the slower voltage drop and the lack of a local voltage minimum observed in the LBCO-coated electrodes are consistent with the suppression of Li plating. Further, when incremental capacity (IC) analysis was performed to plot dQ/dV versus cell voltage, the location of anode voltage minimum is strongly correlated with that of the plating IC peak.

As noted above in conjunction with FIGS. 10-11, the LBCO-HOLE cells maintained a state-of-charge approximately 20% and 10-20% higher than the LBCO cells at respective 4 C and 6 C charge rates, given the same amount of time (i.e., 15 minutes and 10 minutes) in the CC-CV charging protocol at −10° C. The effect is similar at 5° C. (FIGS. 8-9), with the LBCO-HOLE cells maintaining a state-of-charge approximately 25% and 15-20% higher than the LBCO cells at respective 4 C and 6 C charge rates, given the same amount of time in the CC-CV charging protocol. This suggests that even if Li plating can be suppressed at low temperatures, which is achievable via the artificial SEI coating, it is important to facilitate Li ion transport into the thickness of the anode due to sluggish diffusion into the electrode material at low temperatures.

The above-discussed results indicate that the SEI, whether naturally formed as on the control and HOLE anodes or artificially formed as in on the LBCO and LBCO-HOLE anodes, serves a critical role of transporting Li ions between the liquid electrolyte and the anode material during charging and discharging process. The ion transport properties and the impedance of the SEI may therefore be of significant interest. In particular, providing an SEI with better transport properties and lower impedance than the naturally formed SEI layer may be vital to the future of fast-charge Li-ion batteries.

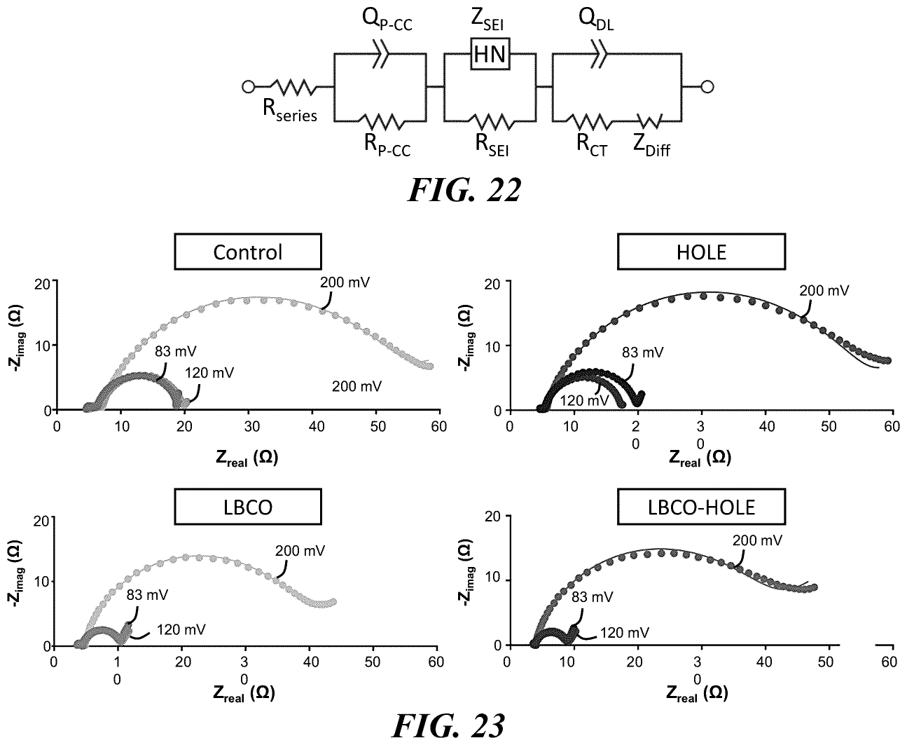

To investigate the properties of the naturally formed SEI and the artificial SEI, electrochemical impedance spectroscopy (EIS) was performed using a VSP Potentiostat (Bio-logic USA). To measure impedance of the each anode, three-electrode ECC-PAT-Core (EL-CELL GmbH) was used with a Li metal ring reference electrode. This enables contributions to the total electrode impedance associated with distinct frequency responses to be decoupled by fitting the spectra with the equivalent circuit model shown in FIG. 22. The measured data was fitted to the model using RelaxIS 3 software suite (rhs instruments GmbH & Co. KG).

With reference to FIG. 22, graphite-based electrodes can be characterized by a series resistance (Rₛₑᵣᵢₑₛ) associated with the ohmic drop, a particle and current collector resistance (R_{P-CC}) associated with the contact between anode material particles (e.g., graphite) and the contact between the anode material and the current collector, an SEI resistance (R_{SEI}) associated with ionic transport through the SEI, a charge transfer resistance (R_{CT}) associated with charge-transfer processes, and a diffusion element Z_{diff} associated with solid-state diffusion within the graphite particles. Charge transfer resistance (R_{CT}) reflects the kinetics of the cell electrochemical reaction, and a high R_{CT} results in high electrochemical polarization. R_{SEI} and R_{P-CC} also increase as the temperature decreases. However, the R_{CT} as a percentage of total cell impedance is nearly 100% as the temperature falls below −20° C. Constant phase elements were used for fitting R_{P-CC} and R_{CT} to account for the suppressed semicircles that are observed. In addition, a Havriliak-Negami (HN) term was used in conjunction with the SEI resistance to capture the asymmetry of the SEI impedance feature in the spectra.

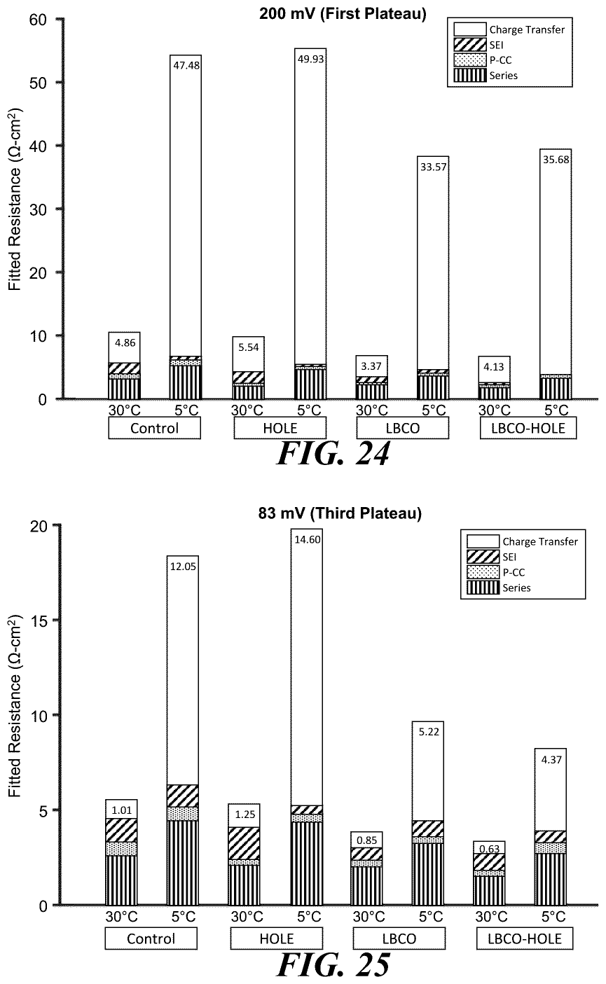

Since the impedance of Li-ion batteries vary as a function of state-of-charge (SOC) and temperature, impedance spectra were collected at different temperatures during charging of the cells (200 mV, 120 mV, 83 mV vs. Li/Li+ at 30° C., 15° C., and 5° C.) as the voltage traces are shown in FIG. 23. As shown in FIGS. 24 and 25, Rₛₑᵣᵢₑₛ and R_{P-CC} are relatively consistent for the four different anode configurations at each temperature and voltage plateau. This is expected since Rₛₑᵣᵢₑₛ and R_{P-CC} are associated with the material properties of the graphite-based anode material and the current collector, which is consistent for all of the tested electrodes and does not change substantially during charging. As the amount of Li intercalated into the anode material increases, R_{CT} decreases, which facilitates charging as the SOC of the battery increases. As shown in FIG. 23, R_{CT} drops significantly from 200 mV to 120 mV vs. Li/Li+ at all temperatures. However, at 83 mV, R_{CT} did not decrease compared to R_{CT} at 120 mV, suggesting that once the cell reaches a threshold SOC, R_{CT} saturates and does not change further as more Li is inserted.

With reference to FIGS. 24-25, the most substantial difference between the control and LBCO anodes was observed in R_{CT} value as the temperature decreased. For the control and HOLE anodes at 5° C., R_{CT} was respectively measured to be 47.48 Ω-cm² and 49.93 Ω-cm² at 200 mV vs. Li/Li+ and decreased to 12.05 Ω-cm² and 14.60 Ω-cm² when the graphite was charged to 83 mV vs. Li/Li+. For the LBCO and LBCO-HOLE anodes at 5° C., R_{CT} was respectively measured to be 33.57 Ω-cm² and 35.68 Ω-cm² at 200 mV vs. Li/Li+ and decreased to 5.22 Ω-cm² and 4.37 Ω-cm² when the graphite was charged to 83 mV vs. Li/Li+. This decreased impedance is believed to be due to the LBCO coating suppressing formation of the natural SEI and the artificial SEI having a higher ionic conductivity than the natural SEI across different temperatures and SOCs. The artificial SEI blocks electron transport, preventing reductive side reactions with the salt and solvents of the liquid electrolyte that lead to natural SEI formation and growth. XPS analysis showed that LBCO as an artificial SEI has an ultrathin LiF surface layer. Both LBCO and LiF exhibit a wide electrochemical stability window, preventing natural SEI formation under reductive conditions.

The lower R_{CT} reduces overall cell polarization at low temperatures and is consistent with the above results showing that the LBCO coating can suppress Li plating under low temperature, fast charging conditions. No substantial difference was observed between the uncoated control and HOLE anodes. This is believed to be because these impedances are attributed to the naturally formed SEI and its interface with the liquid electrolyte.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other. additional components or items. Other terms are to be construed using their broadest reasonable meaning unless they are used in a context that requires a different interpretation.

1. A lithium-ion battery, comprising:
a negative electrode formed from an electrode material;
channels formed at least partially through a thickness of the electrode material;
a coating disposed over the electrode material; and
a liquid electrolyte infiltrating pores of the electrode,
wherein the coating suppresses formation of a solid electrolyte interphase layer from constituents of the liquid electrolyte when the battery is initially charged.

2. The lithium-ion battery of claim 1, wherein the coating is a solid electrolyte material that reduces interfacial resistance relative to said solid electrolyte interface layer.

3. The lithium-ion battery of claim 1, wherein each channel is defined by a channel wall, and the coating is disposed along the channel wall.

4. The lithium-ion battery of claim 3, further comprising a separator confronting a face of the electrode, wherein the coating is present along the face of the electrode and extends along each channel wall from the first face of the electrode.

5. The lithium-ion battery of claim 1, wherein the coating is a conformal coating on the electrode material such that the electrode material is encapsulated by the coating.

6. The lithium-ion battery of claim 1, wherein the electrode material comprises graphite.

7. The lithium-ion battery of claim 6, wherein graphite is the only electrochemically active lithium host material of the electrode material.

8. The lithium-ion battery of claim 6, wherein the electrode material further comprises silicon or hard carbon.

9. The lithium-ion battery of claim 1, wherein the coating is glassy lithium borate-lithium carbonate.

10. The lithium-ion battery of claim 1, wherein the battery has an initial charge capacity and a post-cycling charge capacity that is at least 50% of the initial charge capacity after 100 charge-discharge cycles at a cycling temperature less than or equal to 5° C. and at a charge rate of at least 4 C.

11. The lithium-ion battery of claim 10, wherein the electrode has an areal charge capacity of at least 3 mAh/cm².

12. The lithium-ion battery of claim 10, wherein the post-cycling charge capacity is at least 90% of the initial charge capacity.

13. The lithium-ion battery of claim 10, wherein the cycling temperature is less than or equal to −10° C.

14. The lithium-ion battery of claim 1, wherein each channel has a width in range from 5 μm to 100 μm and each channel is spaced apart from another channel by a distance in a range from 10 μm to 200 μm as measured between centerlines of the channels.

15. The lithium-ion battery of claim 1, wherein the channels are formed by laser ablation.

16. A lithium-ion battery having an initial charge capacity and a post-cycling charge capacity that is at least 90% of the initial charge capacity after 100 charge-discharge cycles at a cycling temperature less than or equal to 5° C. and at a charge rate of at least 4 C, wherein a negative electrode of the battery has an areal charge capacity of at least 3 mAh/cm².

17. The lithium-ion battery of claim 16, further comprising:
a negative electrode formed from a graphite-based electrode material;
an array of laser-formed channels extending at least partially through a thickness of the electrode material, each channel having a width of 100 μm or less; and
an artificial sold electrolyte interphase material encapsulating the electrode material and having a thickness of 100 nm or less.

18. A method comprising the step of charging a lithium-ion battery at a temperature less than or equal to 5° C. at a charge rate of at least 4 C, wherein the battery is configured to suppress formation of lithium plating on a negative electrode of the battery during the step of charging.

19. The method of claim 18, further comprising the steps of:
(a) discharging the lithium-ion battery after the step of charging; and
(b) repeating the steps of charging and discharging at least 100 times each,
wherein the battery is substantially free from lithium plating on the negative electrode after step (b).

20. The method of claim 19, wherein the battery retains at least 90% of an initial charge capacity after step (b).

21. The method of claim 18, further comprising, before the step of charging:
(a) constructing the battery from the negative electrode, a positive electrode, a separator, and a liquid electrolyte; and
(b) providing the negative electrode with an artificial solid electrolyte interphase coating before step (a),
wherein the coating suppresses formation of lithium plating on the negative electrode during the step of charging.

22. The method of claim 21, wherein step (b) includes atomic layer deposition of the coating.

23. The method of claim 21, further comprising the step of forming channels at least partially through a thickness of an electrode material of the negative electrode via laser ablation before step (b).
